(19) United States
(12) Patent Application Publication
(10) Pub. No.: US 2016/0159469 A1
(43) Pub. Date: Jun. 9, 2016

(54) METHOD FOR USING AIRCRAFT WHEEL TYRE PRESSURE TO IMPROVE AIRCRAFT ENERGY EFFICIENCY AND DRIVE SYSTEM PERFORMANCE

(71) Applicant: Borealis Technical Limited, North Plains, OR (US)

(72) Inventors: Jan Vana, Prague (CZ); Isaiah W. Cox, London (GB); Joseph J. Cox, Portland, OR (US); Jonathan S. Edelson, Portland, OR (US); Nechama Cox, London (GB)

(21) Appl. No.: 14/559,929

(22) Filed: Dec. 4, 2014

(51) Int. Cl. B64C 25/34; B60C 23/02; B60C 23/00

(52) U.S. Cl. CPC B64C 25/34; B60C 23/001; B60C 23/02

(57) ABSTRACT

A method for improving both drive system performance and energy efficiency performance both in an aircraft equipped with one or more drive wheel drive systems to move the aircraft autonomously on the ground is provided and in an aircraft that relies on its engines for ground movement. Achieving these objectives takes advantage of a discovered relationship between aircraft tyre pressure, drive system performance, and energy efficiency. Monitoring and maintaining tyre inflation pressure of an aircraft's tyres at an inflation level near a high end or recommended maximum cold or hot operating pressure for a specific kind of aircraft tyre on a specific aircraft not only improves drive wheel drive system performance, but also substantially and significantly improves energy efficiency in all types of aircraft.

### PRIORITY CLAIM

This application claims priority from U.S. Provisional Patent Application No. 61/712,260, filed Oct. 11, 2012, the disclosure of which is fully incorporated herein.

### TECHNICAL FIELD

The present invention relates generally to achieving improvements in energy efficiency and in performance of aircraft drive systems and specifically to improvements that can be achieved both in reduction of aircraft energy consumption and in aircraft drive wheel drive system performance based on a relationship between aircraft wheel tyre pressure and energy efficiency performance, as well as tyre pressure and drive system performance.

### BACKGROUND OF THE INVENTION

It is widely recognized that maintaining correct pressure in vehicle tyres results in increased fuel efficiency and increased safety. Fuel efficiency is enhanced when a properly filled tyre maintains a tyre manufacturer's recommended contact patch with a drive surface, thereby decreasing rolling resistance. Under- and over-inflated tyres are likely to fail as a result of stresses on tyre components, blowouts, or other causes and, consequently, can present a significant hazard risk for an operating vehicle. When the recommended pressure for a tyre is maintained, the likelihood of such risks should be minimized. Like some other vehicle tyres, aircraft tyres are designed to carry specified loads through a range of temperatures and wheel speeds. Unlike the tyres of vehicles that travel solely on ground surfaces, however, aircraft tyres must withstand pressure at different altitudes and the forces associated with landing and takeoff, as well as travel conditions on ground surfaces. Aircraft tyres have long been required to be filled with nitrogen gas, which both reduces fire risks and extends tyre useful life. Even when aircraft tyres are filled with nitrogen, however, maintaining correct pressure in aircraft tyres is a key factor in ensuring that aircraft tyres and the wheel assemblies supporting them perform safely and reliably under the high static and dynamic loads encountered during landing, taxi, and takeoff. Taking steps to ensure that correct tyre pressure is maintained is of the utmost importance for safe aircraft ground movement and operation.

It has been proposed to drive aircraft independently during taxi using motors and other drive means to move one or more drive wheels to produce aircraft ground movement. U.S. Pat. No. 7,445,178 to McCoskey et al, for example, describes electric nose wheel drive motors intended to drive aircraft during taxi. U.S. Pat. No. 7,469,858 to Edelson; U.S. Pat. No. 7,891,609 to Cox; U.S. Pat. No. 7,975,960 to Cox; U.S. Pat. No. 8,109,463 to Cox et al; and British Patent No. 2457144, owned in common with the present invention, describe aircraft drive systems that use electric drive motors to power aircraft wheels and move an aircraft on the ground without reliance on aircraft main engines or external tow vehicles. While the drive means described in these patents can effectively move an aircraft autonomously during ground operations, there is no suggestion of a relationship between efficient autonomous aircraft taxi and aircraft tyre pressure.

When aircraft are equipped with one or more drive wheels powered by drive systems to move the aircraft on the ground autonomously without using the aircraft's main engines or external tow vehicles, operation of the components of a drive wheel drive system is likely to have at least some effect on tyre pressure. It is possible that tyre pressure may also have some effect on drive system operation. The prior art, however, fails to acknowledge or suggest any such relationships.

### SUMMARY OF THE INVENTION

It is a primary object of the present invention, therefore, to take advantage of a discovered relationship between aircraft tyre pressure and aircraft energy consumption and between aircraft tyre pressure and aircraft drive wheel drive system performance and to provide a method for improving both energy efficiency performance and drive system performance in an aircraft equipped with one or more drive wheel drive systems to move the aircraft autonomously on the ground that is based on maintaining aircraft wheel tyre pressure at a level found to achieve both objectives.

It is another object of the present invention to provide a method for improving energy efficiency and drive means performance in an aircraft equipped with one or more drive wheel drive systems to move the aircraft autonomously on the ground by selectively maintaining aircraft wheel tyre pressure at a level found to produce significant fuel or other energy savings and enhance drive system performance.

It is an additional object of the present invention to provide a method for improving both drive system performance and energy efficiency performance in an aircraft equipped with one or more drive wheel drive systems to move the aircraft autonomously on the ground wherein the pressure of all aircraft tyres is maintained at an inflation level near a recommended maximum cold or a recommended maximum hot operating pressure.

It is a further object of the present invention to provide a method that enhances drive system acceleration and drive means heat reduction in an aircraft equipped with one or more drive wheel drive systems to move the aircraft autonomously on the ground, wherein aircraft wheel tyre pressure is maintained at an inflation level near a recommended maximum cold or hot operating pressure.

It is yet another object of the present invention to provide a method for reducing rolling resistance and thereby significantly improving energy efficiency in an aircraft equipped with one or more drive wheel drive systems to move the aircraft autonomously on the ground, and in an aircraft without such drive systems, when the pressure of all aircraft tyres is selectively maintained at an inflation level near a recommended hot or cold maximum tyre operating pressure.

It is yet an additional object of the present invention to provide a method for improving drive system performance in an aircraft equipped with one or more drive wheel drive systems to move the aircraft autonomously on the ground, wherein the inflation pressure of the aircraft's tyres can be varied to simulate a weight change.

It is yet a further object of the present invention to provide a method for improving energy efficiency performance in an aircraft using the aircraft main engines to move the aircraft on the ground that is based on maintaining aircraft wheel tyre pressure at an inflation pressure level found to minimize engine energy consumption.

It is a still further object of the present invention to provide a method for reducing fuel burn and/or energy consumption in an aircraft driven on the ground by the aircraft's main engines, wherein inflation pressure of tyres on all aircraft wheels is maintained at an inflation pressure level near a recommended maximum cold or a maximum hot operating pressure.

In accordance with the aforesaid objects, a method for improving reducing energy and/or fuel consumption in all aircraft and for improving both drive system performance and energy efficiency performance in an aircraft equipped with one or more drive wheel drive systems to move the aircraft autonomously on the ground is provided. Achieving these objectives takes advantage of a discovered relationship between aircraft wheel tyre pressure and reduction of energy consumption and a relationship between aircraft tyre pressure, drive system performance, and energy efficiency. When aircraft wheel tyre pressure is maintained at an inflation level near a high end or recommended maximum cold or hot operating pressure for the specific aircraft tyre, this not only substantially and significantly improves aircraft energy efficiency, but also improves drive wheel drive system performance in aircraft equipped with drive wheel drive systems. Maintenance of tyre pressure of all of an aircraft's tyres near the recommended maximum hot or cold pressures has been found to reduce rolling resistance and significantly reduce energy or other fuel consumption. Maintenance of tyre pressure near the recommended maximum additionally enhances drive wheel drive system acceleration and reduces drive system heating in aircraft equipped with one or more drive wheel drive systems.

Other objects and advantages will be apparent from the following description, claims, and drawings.

### BRIEF DESCRIPTION OF THE DRAWING

FIG. 1 is a view of a portion of an aircraft landing gear drive wheel with one configuration of a drive system capable of driving the wheel and the aircraft autonomously on the ground in an aircraft equipped with a drive wheel drive system.

### DESCRIPTION OF THE INVENTION

It is acknowledged in the airline industry that improperly inflated aircraft tyres can significantly compromise the safety of aircraft operations. As a result, the United States Federal Aviation Administration (FAA) and corresponding international aviation authorities continuously emphasize the importance of maintaining properly inflated aircraft tyres to prevent the occurrence of potentially catastrophic events. These authorities suggest that frequent tyre checks be conducted to ensure aircraft tyres remain inflated to within an inflation range, typically that specified in a maintenance manual for the aircraft. Since an aircraft tyre may lose up to five percent (5%) of tyre pressure a day under typical operations, frequent pressure checks are required to maintain correct tyre pressure and avoid premature tyre replacement. Ideally, tyre pressure should be checked at a time that ensures maintenance of the recommended tyre pressure for each flight cycle.

Aircraft tyre manufacturers typically recommend a daily cold tyre inflation pressure check that also records the ambient or environmental temperature. The term “cold tyre” refers to a tyre that is about the same temperature as the surrounding, or ambient, air, usually after a postflight cooling period of about 2 to 3 hours. The terms “hot tyre” and “warm tyre” are used to refer to any tyre with a carcass temperature that exceeds the ambient temperature by about 30° C. (54° F.). While pressure and temperature can be measured for both cold and hot or warm tyres, pressure adjustments are generally made on cold tyres for optimum safety and reliability. A comparison of tyre pressures on adjacent tyres or pairs of tyres mounted on nose or main landing gear wheels is recommended to verify that the pressures of both tyres are substantially the same and at least equal to the specified operational loaded pressure. Maintaining optimum inflation pressures for all aircraft tyres, however, whether they are mounted on nose or main landing gear wheels, is recommended. Generally, at ambient temperatures, aircraft tyre pressures should not exceed the specified operational pressure by more than about 5%. The pressure of a hot tyre may exceed the specified operational pressure by much greater than 5%, however.

Specified operating pressures for aircraft tyres may range from about 150 pounds per square inch (psi) to about 230 psi (10 bars to 16 bars) or possibly lower or higher for some tyres. The minimum service pressure for safe aircraft operation is typically the cold unloaded inflation pressure specified by the airframe manufacturer. The recommended safe aircraft tyre operating range may include a tolerance of −0% to +5% of the minimum service pressure. Monitoring and maintaining aircraft tyre pressure at the inflation levels described above is critical and clearly helps to prevent hazardous failures. Until the present invention, however, it has not been appreciated that monitoring and maintaining an aircraft tyre pressure at a value or level near a recommended cold or a recommended hot maximum tyre operating pressure could have effects beyond improving safety. Nor was it directly recognized that aircraft tyre pressure could reduce energy consumption in all aircraft, including aircraft that rely on their main engines for ground travel and those that employ drive wheel drive systems to move aircraft without reliance on an aircraft's main engines during taxi. Significantly improving energy efficiency by maintaining aircraft tyre pressure near a recommended cold or hot maximum operating pressure in an aircraft with or without drive wheels for independent movement has not heretofore been acknowledged. Further, it was not recognized that aircraft tyre pressure could have any effect on drive wheel drive system performance in an aircraft equipped with one or more drive systems to move the aircraft autonomously during taxi.

The inventors of the present invention have discovered that aircraft equipped with one or more drive wheel drive systems capable of driving the aircraft autonomously on the ground without reliance on the aircraft's main engines or external tow vehicles, as well as aircraft not equipped with such drive wheels or drive systems, demonstrate not only the operational safety referred to above, but also show improved energy efficiency performance when all of the aircraft's tyres are at an inflation pressure that is at about the recommended maximum or high end pressure. Improvements in drive system operation in aircraft with drive wheel drive systems are also demonstrated. These advantages are achieved when tyre pressure is at about the recommended cold maximum pressure and at about the recommended hot maximum pressure. The specific maximum pressure values will depend, at least in part, on manufacturer's recommendations, but may also be influenced by other factors encountered during aircraft ground movement. A superior reduction in rolling resistance is unexpectedly realized when tyre pressures are at about these recommended maximum pressures. A concomitant reduction in rolling resistance is not seen when tyre pressures are at about the recommended minimum or low end pressure, however. An unexpectedly significant reduction in aircraft fuel consumption rate during autonomous drive system-powered aircraft taxi and during engine-powered aircraft taxi is observed when wheel tyre pressure is at about the maximum recommended inflation operating pressure for the specific kind of tyres mounted on the aircraft's wheels.

The use of the terms “near a recommended maximum” and “at about a recommended maximum” are intended to refer to a tyre inflation pressure close to or approaching a maximum recommended cold or hot inflation pressure value or level. As noted, manufacturers of different types or models of aircraft tyres recommend maximum cold and hot inflation pressures for their tires that should not be exceeded.

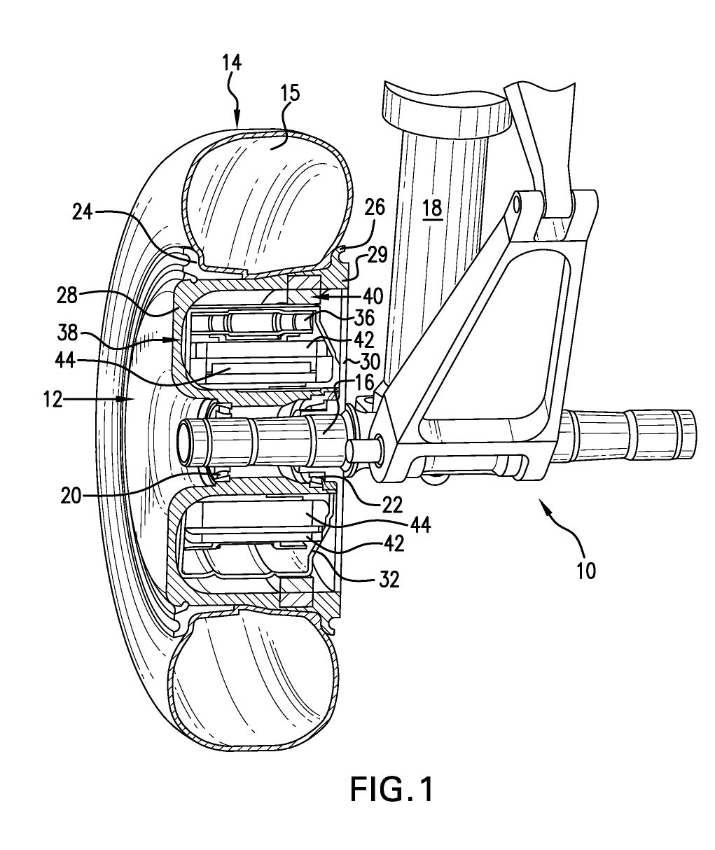

Referring to the drawing, FIG. 1 shows, in cross-sectional perspective view, a portion of an aircraft landing gear 10 and a landing gear wheel 12 with one configuration of a drive wheel drive system mounted within the landing gear wheel in an aircraft equipped with a drive wheel driven on the ground by a drive system. Although only one landing gear wheel is shown in detail, it is contemplated that one or more nose landing gear wheels, one or more main landing gear wheels, or a combination of nose and main landing gear wheels could be equipped with drive wheel drive systems as described herein. In one possible arrangement, for example, equipping both wheels in a two-wheel nose landing gear with a drive wheel drive system provides the capability not only to effectively move the aircraft on the ground, but also to differentially steer and brake the aircraft by selective activation of the drive means of each wheel.

A tyre 14 is shown mounted on the wheel 12. The wheel 12 and tyre 14 are rotatably mounted on an axle 16 attached to the landing gear 10. The landing gear 10 includes a central piston 18 and other standard landing gear structures (not identified) typically found in an aircraft nose or main landing gear. The wheel 12 is rotatably supported on the axle 16 by support structures, such as the bearing arrangements 20 and 22 shown adjacent to the axle 16. Other suitable support structures or bearings could also be used for this purpose. The wheel 12 preferably has the two part configuration shown in FIG. 1, although other wheel designs could also be employed.

Removal and remounting of the tyre 12 is facilitated by providing a demountable tyre flange 24 on an outboard side of the wheel 12 that can be removed when necessary. The demountable flange could also be located on the inboard side of the wheel. A stationary tyre flange 26, shown here on the inboard side of the wheel, is provided to hold an opposite side of the tyre 14. The stationary tyre flange is integrally formed with a portion 29 of a substantially “C”-shaped outboard wheel wall section 28 that forms most of the wheel. A smaller inboard wheel wall section 30 connects to the outboard wheel section 28 to define a maximum space or volume within the wheel 12 where components of an aircraft drive wheel drive system can be mounted. Other aircraft wheel configurations that support tyres are also contemplated to be within the scope of the present invention.

The tyre 14 includes a valve stem (not shown) that provides a fluid connection with the tyre interior 15 to allow inflation and/or deflation of the tyre. Tyre pressure and/or temperature sensors (not shown) may be included to facilitate the automatic monitoring of tyre temperature and/or pressure, and a suitable processor (not shown) may be provided to process pressure and/or temperature data and communicate the data to a pilot or flight crew in the aircraft cockpit so that appropriate action can be taken to adjust tyre pressure manually or automatically. A range of such sensors and processors is available and can be adapted for this purpose, if necessary. Intelligent software could also be included to automatically determine whether tyre pressure is at a selected level in response to sensed environmental, tyre, and/or drive system conditions or operating parameters and communicate this information to the cockpit or possibly ground control so that tyre pressure can be adjusted at an appropriate time. Apparatus for automatically adding nitrogen gas to a tyre with a lower than selected inflation pressure level or releasing gas from a tyre with an inflation pressure that is higher than a selected inflation pressure level may also be provided. The preferred selected inflation pressure level may be a pressure value at about the recommended operating cold or hot maximum inflation pressure for the specific kind of tyres mounted on an aircraft's drive wheels and on an aircraft's other wheels that are not equipped with drive systems as described herein.

A processor used in connection with monitoring tyre pressure as described above may be adapted to have the capability for logging the inflation pressure of all aircraft tyres or selected aircraft tyres at selected intervals during a period of time, a number of flight cycles, or any other length of time when an aircraft is operating on the ground. This information can be analyzed and used to optimize performance of the drive system in an aircraft equipped with one or more drive wheel drive systems to move the aircraft on the ground. This information may also be used in an aircraft that relies on its main engines for ground movement to effectively reduce fuel burn during taxi.

When, for example, both wheels in a nose landing gear are equipped with drive systems to power an aircraft during ground travel, pressure sensors and software could be programmed to compare the pressure of each nose wheel tyre and to communicate this information. Any required adjustments can then be made to ensure that the pressures of both tyres are substantially equal and are at about the recommended maximum hot or cold inflation pressure. The pressures and temperatures of other aircraft wheel tyres could additionally be automatically monitored and then adjusted as described. Tyre pressure may also be checked manually or using an available wireless system, and the necessary adjustments made manually right away. Whether tyre pressure is monitored automatically or manually, pressure sensors and/or monitors should be checked regularly and calibrated as required to ensure that pressure and other measurements are as accurate as possible.

The drive system in an aircraft equipped with a drive wheel drive system could additionally be adapted to identify a tyre pressure deviation from the selected inflation pressure by sensing and comparing the relative work and output of the drive system. When more work is required by the drive system for less output or benefit, a signal alerting the crew to that situation may be sent to the cockpit, and an indicator, such as, for example, a yellow or other colored light or an audible tone, would be activated, indicating that a maintenance check is required. The drive system could be adapted for onboard measurement of tyre pressure directly, or to infer tyre pressure from work, output, or the like, and alert the cockpit or ground control when inflation pressure varies from the maximum hot or cold tyre pressure. Tyre pressure can then be corrected manually at an appropriate time.

One possible configuration and arrangement of components of an aircraft drive wheel drive system is shown in FIG. 1. Other functionally equivalent arrangements and configurations are also contemplated to be useful with the present method. In the configuration shown, the components of the drive system are enclosed within a housing 32 that is shaped to fit completely within the maximized space created by the arrangement of the respective outboard and inboard wall sections 28 and 30 of the wheel 12. The main elements of the drive wheel drive system may preferably include a drive system 36 operatively positioned between a non-engine drive means 38 and a clutch assembly 40, with these components preferably relatively positioned as shown in FIG. 1, although other relative positions of drive system components could also be employed.

A preferred non-engine drive means 38 includes a rotating element, such as a rotor 42, and a stationary element, such as a stator 44. The rotor 42 is preferably located externally of the stator 44, as shown, but other drive means component arrangements could also be used and are contemplated to be within the scope of the present invention. For example, the positions of the rotor 42 and stator 44 could be reversed so that the rotor is internal to the stator.

One type of drive means 38 preferred for use with the aircraft drive wheel drive system of the present invention is an electric motor assembly that is capable of operating at high speed and could be any one of a number of suitable designs. An exemplary drive means is an inside-out electric motor in which the rotor can be internal to or external to the stator, such as that shown and described in U.S. Patent Application Publication No. 2006/0273686, the disclosure of which is incorporated herein by reference. A range of motor designs capable of high torque operation across a desired speed range capable of moving an aircraft wheel and functioning as described herein may also be suitable drive means in an aircraft drive wheel drive system. A high phase order electric motor of the kind described in, for example, U.S. Pat. Nos. 6,657,334; 6,838,791; 7,116,019; and 7,469,858, the disclosures of the aforementioned patents are incorporated herein by reference, can be effectively used as a drive means 38. Another example of a suitable drive means 38 is a high phase order induction motor with a top tangential speed of about 15,000 linear feet per minute and a maximum rotor speed of about 7200 rpm, although drive means capable of a wide range of such speeds could also be used. Other drive means, including hydraulic and/or pneumatic drive means, are also contemplated to be within the scope of the present method. Power for an electric drive means is preferably supplied by the aircraft auxiliary power unit (APU), but could be supplied by any other source of electrical energy.

The drive wheel drive system 36 may be gearing or a gear system. Alternatively, a roller traction drive or other functionally equivalent drive system may be incorporated in the drive system instead of gearing. A preferred drive system 36 designed to actuate a non-engine drive means 38 that is capable of moving a commercial sized aircraft on the ground not only has a low profile and is light weight, but also provides the high torque and high speed change ratio required to optimally operate the drive means to move an aircraft on the ground.

A clutch assembly 40 provided in the preferred aircraft drive wheel drive system may be activated automatically or manually to engage and disengage the gearing, roller traction drive, or other drive system into and out of actuation with the non-engine drive means 38. The non-engine drive means 38 is actuated by the drive system 36 to move the aircraft wheel 12 to drive the aircraft on the ground between landing and takeoff and during other ground travel, such as, for example, into and out of maintenance facilities. When appropriate, the clutch assembly 40 may deactivate the drive system 36 to deactuate the non-engine drive means 38 so that the drive means is unable to drive the aircraft wheel. The clutch assembly 40 should be operably positioned to move into and out of engaging contact with the drive system 36. The drive system 36 should only be engaged by the clutch assembly 40 to actuate the drive means 38 when the aircraft is actually on the ground, such as after landing and prior to takeoff, and when the aircraft is traveling at a desired speed during ground travel.

One or more failsafe mechanisms (not shown) may be provided to prevent the clutch assembly 40 from engaging the drive system 36 when the aircraft landing gear wheels are not supporting the aircraft on the ground, such as, for example, when the aircraft is in flight and at other times when an aircraft landing gear wheel should not be driven. If desired, these failsafe mechanisms may be programmed to automatically disengage or prevent engagement of the clutch assembly in the event that tyre pressure is not maintained at about a selected maximum hot or cold operating pressure level to prevent the aircraft drive wheel to be driven to move the aircraft.

Maintaining the pressure of an aircraft tyre 14 close to the cold or hot high end of recommended tyre inflation pressure produces benefits not attributable to or equivalent to any that might be realized by increasing tyre inflation pressure to normal when a tyre has been underinflated. Improvements in automobile fuel efficiency have been observed when the pressure of underinflated tyres is increased to a recommended normal tyre pressure. The increase in aircraft energy efficiency actually produced by the present method of maintaining aircraft tyre pressure at about the recommended cold or hot maximum pressure far surpasses any expected fuel or other energy efficiency improvement based on fuel savings achieved in automobiles, however. The pressure of all of an aircraft's tyres should be at about the recommended cold or hot maximum operating pressure for these tyres to achieve optimal energy efficiency, as well as the other benefits described herein.

In addition to the unexpected substantial energy savings possible when tyre pressure of aircraft equipped with drive systems as described herein is maintained at about the recommended cold or hot maximum pressure, the performance of the drive system is also enhanced. Improvements in drive system performance that can be achieved when tyre pressure is at the high end, or recommended maximum operating pressure, include enhanced drive system acceleration and reduced drive system heating. Other benefits associated with a drive system that does less work for the same output or the same work for more output can additionally be realized with the present invention.

A further aspect of the present method is the ability to simulate aircraft weight change by varying tyre pressure. Maintaining tyre pressure at about the maximum recommended operational pressure clearly achieves superior fuel efficiency performance and enhances aircraft drive system performance. As discussed above, rolling resistance is reduced when tyre pressures are kept at these levels. Reducing tyre pressure to the low end or minimum recommended operational pressure can simulate a weight change and produce increased rolling resistance in situations when this would be desirable. The use of an automated system of pressure sensors and monitors allows tyre pressure reductions to be accomplished automatically when circumstances warrant this.

While the present invention has been described with respect to preferred embodiments, this is not intended to be limiting, and other arrangements, structures, and steps that perform the required functions are contemplated to be within the scope of the present invention.

### INDUSTRIAL APPLICABILITY

The method for improving aircraft fuel efficiency performance using aircraft wheel tyre high end inflation pressures of the present invention will find its primary applicability in aircraft equipped with one or more drive wheel drive systems operable to drive an aircraft autonomously on the ground without reliance on the aircraft's main engines or external ground vehicles and in aircraft that rely on the main engines to move on the ground. Aircraft equipped with drive wheel drive systems may realize additional improvements in drive system performance when tyre pressure is maintained at about a recommended cold or hot maximum operating pressure.

1. A method for significantly improving aircraft energy efficiency comprising, in an aircraft having wheels and inflatable tyres mounted on each of the aircraft's wheels, maintaining a tyre inflation pressure level in each of said tyres at about a selected maximum recommended hot inflation pressure level or at about a cold inflation pressure level for said type of inflatable tyre and reducing aircraft energy consumption during ground travel when said the inflation pressures of said tyres is maintained at said selected inflation pressure.

2. The method of claim 1, further comprising equipping one or more of said aircraft wheels with a drive wheel drive system capable of moving the aircraft autonomously without reliance on said aircraft's main engines during ground travel.

3. The method of claim 2, further comprising selecting and maintaining an inflation pressure level in said tyres determined to significantly reduces energy consumption while said aircraft is autonomously moved on the ground by said drive wheel drive system.

4. The method of claim 2, further comprising selecting and maintaining an inflation pressure level in said tyres determined to enhance acceleration of said aircraft drive wheel drive system while said aircraft is autonomously moved on the ground by said drive wheel drive system.

5. The method of claim 2, further comprising selecting and maintaining an inflation pressure level in said tyres determined to reduce heating of said aircraft drive wheel drive system while said aircraft is autonomously moved on the ground by said drive wheel drive system.

6. The method of claim 1, further comprising and maintaining an inflation pressure level in all of the aircraft's tyres determined to reduce rolling resistance between said inflatable tyres and an aircraft ground travel surface while said aircraft is moving on the ground.

7. The method of claim 1, further comprising providing tyre inflation pressure sensor means to sense and monitor said inflation pressure level.

8. The method of claim 7, wherein said pressure sensor means automatically measures said inflation pressure level in one or more of said tyres and communicates a variation between a measured inflation pressure value and the selected inflation pressure value in one or more of said tyres to an indicator in a cockpit of said aircraft.

9. The method of claim 2, wherein a selected inflation pressure value determined to substantially reduce energy consumption, enhance acceleration of said aircraft drive wheel drive system, and reduce heating of said aircraft drive wheel drive system while said aircraft is autonomously moved on the ground by said drive wheel drive system is maintained in each of said tyres on said aircraft.

10. The method of claim 1, wherein said aircraft is moved during ground travel by one or more of said aircraft's main engines.

11. The method of claim 10, further comprising providing tyre inflation pressure sensor means to sense and monitor said inflation pressure level in each said tyre, wherein said pressure sensor means automatically monitors and measures said inflation pressure in each said inflatable tyre and communicates a variation between measured tyre inflation pressure and selected tyre inflation pressure to indicator means in a cockpit of said aircraft.

12. The method of claim 1, further comprising providing tyre inflation pressure monitoring means for measuring an inflation pressure level of said aircraft tyres in communication with a processor; wherein said pressure monitoring means communicates measured inflation pressures to said processor, and said processor logs measured inflation pressures over a selected time interval and analyzes logged inflation pressures, whereby tyre inflation pressure levels are adjusted as required to reduce energy consumption and maximize energy efficiency on the basis of analyzed logged inflation pressures.

13. The method of claim 1, wherein tyre inflation pressure is maintained at said selected inflation pressure level in all of an aircraft's inflatable tyres at substantially all times during aircraft ground travel.

14. The method of claim 2, wherein said drive wheel drive system includes sensor means adapted to directly or indirectly sense and measure or infer a tyre inflation pressure level, wherein said drive wheel drive system sends a signal to a cockpit in said aircraft when measured or inferred tyre inflation pressure varies from said selected tyre inflation pressure.

15. A method for improving aircraft drive wheel performance and energy efficiency during aircraft ground travel comprising:
a. equipping one or more wheels of an aircraft with one or more drive wheel drive systems capable of moving the aircraft autonomously during ground travel without operation of the aircraft's main engines, wherein each of said aircraft's wheels has an inflatable tyre mounted thereon;
b. inflating each said inflatable tyre to a selected inflation pressure level comprising a pressure at about a recommended hot maximum pressure value or a pressure at about a recommended cold maximum pressure value recommended for said inflatable tyre type; and
c. monitoring and logging said selected inflation pressure in said inflatable tyres during aircraft ground travel to ensure that tyre inflation pressure can be kept near a selected inflation pressure level determined to maximize drive system performance and energy efficiency.
